(19) United States
(12) Patent Application Publication
(10) Pub. No.: US 2017/0334030 A1
(43) Pub. Date: Nov. 23, 2017

(54) AIR DISCHARGE METHOD FOR PNEUMATIC TOOL AND DEVICE THEREOF

(71) Applicant: Jih I Enterprises Co., Ltd., New Taipei City (TW)

(72) Inventor: Wei-Che HSIAO, New Taipei City (TW)

(21) Appl. No.: 15/193,372

(22) Filed: Jun. 27, 2016

(30) Foreign Application Priority Data
May 19, 2016 (TW) 105115499

(51) Int. Cl. B23Q 11/00; B23B 45/04; B25F 3/00; B25F 5/00

(52) U.S. Cl. CPC B23Q 11/005; B25F 5/00; B23B 45/04; B25F 3/00

(57) ABSTRACT

An air discharge method for pneumatic tool and device thereof, comprising a tool body of a pneumatic tool installed with an air guide element provided with a first air vent hole and a second air vent hole, and a brake element provided with a first air guide hole and a second air guide hole that is mounted and disposed on the air guide element, When using the pneumatic tool, the adjustment element is rotated in a clockwise or counter-clockwise direction to cause the air guide element to cover the first air guide hole of the brake element, which enabling backward discharge of air and preventing dust from flying upward to facilitate drilling operations, or the adjust element is rotated to cause the air guide element to cover the second air guide hole of the brake element, which enabling forward discharge of residual shards to facilitate cutting operations.

### BACKGROUND OF THE INVENTION

### (a) Field of the Invention

The present invention relates to an air discharge method for pneumatic tool and device thereof, and more particularly to an air discharge method and device thereof that enables backward discharge of air using a simple and easy adjusting rotation to prevent dust from flying upward when using a pneumatic tool and facilitate drilling operations, or enables forward discharge of residual shards to facilitate cutting operations.

### (b) Description of the Prior Art

The structure of general pneumatic tools comprise components including a tool body fitted with an air cylinder, a piston, and a valve seat set. When using the pneumatic tool, the different components are disposed on the front end of the air cylinder, thereby enabling cutting and drilling operations to be carried out after starting up the pneumatic tool. However, because residual shards are produced that fly upwards during cutting operations, and dust is produced that flies upwards when drilling, the line of vision of the tool operator is not only obstructed, moreover, the working operating procedure is also affected. Hence, pneumatic tools of the prior art are all fitted with an air discharge device, which appropriately expels residual shards or dust produced during the operating procedure. Although the aforementioned air discharge device can improve the shortcomings of residual shards or dust affecting the working operation, however, existing pneumatic tools are only able to effect an unidirectionally discharge function (forward discharge or backward discharge), and it is not possible to select forward or backward discharge of air (residual shards or dust) according to actual operating requirements. Hence, the user needs to prepare two pneumatic tools, which increases operating costs and thus extremely unideal.

A prior art design of an air discharge method for pneumatic tool and device thereof was previously designed by the inventor of the present invention, and a new patent application for the design was separately submitted in the Republic of China and the U.S. (R.O.C. Patent Application No. 104119711, U.S. patent application Ser. No. 14/826,469). Although the aforesaid invention made improvements on pneumatic tools of the prior art that were only able to unidirectionally discharge residual shards or dust, enabling a pneumatic tool to perform backward discharge of air and forward discharge of residual shards during use to facilitate operation of the pneumatic tool, however, the aforementioned previous design is still insufficiently ideal, and there is still the worry of air leakage. Accordingly, through ongoing research and experimentation, the inventor of the present invention finally succeeded in producing further improvements that enable an air discharge device for a pneumatic tool to achieve the objects of superior effectiveness in the directional change of air discharge, savings in manufacturing costs, and increasing the serviceable life of the pneumatic tool.

### SUMMARY OF THE INVENTION

The primary object of the present invention lies in providing an air discharge method for pneumatic tool and device thereof that enables backward discharge of air using a simple and easy adjusting rotation to prevent dust from flying upward when using a pneumatic tool and, thus, facilitate drilling operations, or enables forward discharge of residual shards to facilitate cutting operations.

In the aforementioned air discharge method for pneumatic tool and device thereof, a tool body of a pneumatic tool is installed with an air guide element provided with a first air vent hole and a second air vent hole, and a brake element provided with a first air guide hole and a second air guide hole that is mounted and disposed on the air guide element, wherein the brake element is driven by an adjustment element, which causes the brake element to rotate along the air guide element. Accordingly, when using the pneumatic tool, the adjustment element is rotated in a clockwise or counter-clockwise direction to cause the air guide element to cover the first air guide hole of the brake element, which superposes the second air vent hole over the second air guide hole, thereby enabling backward discharge of air and preventing dust from flying upward to facilitate drilling operations, or the adjustment element is rotated to cause the air guide element to cover the second air guide hole of the brake element, which superposes the first air vent hole over the first air guide hole, thereby enabling forward discharge of residual shards to facilitate cutting operations.

In the aforementioned air discharge method for pneumatic tool and device thereof, the outer edge of the air guide element is provided with positioning ribs, and the tool body is provided with rabbets, so that when fixing the air guide element to the tool body, the positioning ribs are used to insert and dispose into the rabbets to fix the position of the air guide element.

In the aforementioned air discharge method for pneumatic tool and device thereof, the air guide element is provided with cut-open grooves at appropriate positions between the positioning ribs, and the brake element is provided with protruding posts. After mounting and disposing the brake element on the air guide element, the protruding posts are used to precisely insert and dispose into the cut-open grooves of the air guide element to fix the position of the brake element. Accordingly, when the adjustment element is rotated, thereby rotating the brake element, the air guide element is caused to cover the first air guide hole of the brake element, and the second air vent hole is caused to superpose over the second air guide hole, or the air guide element is caused to cover the second air guide hole of the brake element, and the first air vent hole is caused to superpose over the first air guide hole.

In the aforementioned air discharge method for pneumatic tool and device thereof, the brake element is provided with symmetrically positioned screw holes that provide locking of the protruding posts therein, and the adjustment element is provided with grooves in the inner edge thereof to enable inserting and disposing the protruding posts therein. Accordingly, when rotating the adjustment element, pinning down of the protruding posts in the grooves so is used to further drive rotation of the brake element.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 and FIG. 2 are exploded perspective views of the present invention.

FIG. 3 is a perspective view of a tool body of the present invention.

FIG. 3A is a partial cross-sectional enlarged view of the tool body of the present invention.

FIG. 4 is a perspective view of an adjustment element of the present invention.

FIG. 4B is a partial cross-sectional enlarged view of the adjustment element of the present invention.

FIG. 5 is a state diagram of forward air discharge according to the present invention.

FIG. 6 is a state diagram of backward air discharge according to the present invention.

FIG. 7 is a state diagram of air vent holes and air guide holes when discharging air forward according to the present invention.

FIG. 8 is a state diagram of air vent holes and air guide holes when discharging air backward according to the present invention.

FIG. 9 is a state diagram depicting detachment of the adjustment element of the present invention.

FIG. 9C is a partial enlarged view depicting detachment of the adjustment element of the present invention.

### DETAILED DESCRIPTION OF THE PREFERRED EMBODIMENTS

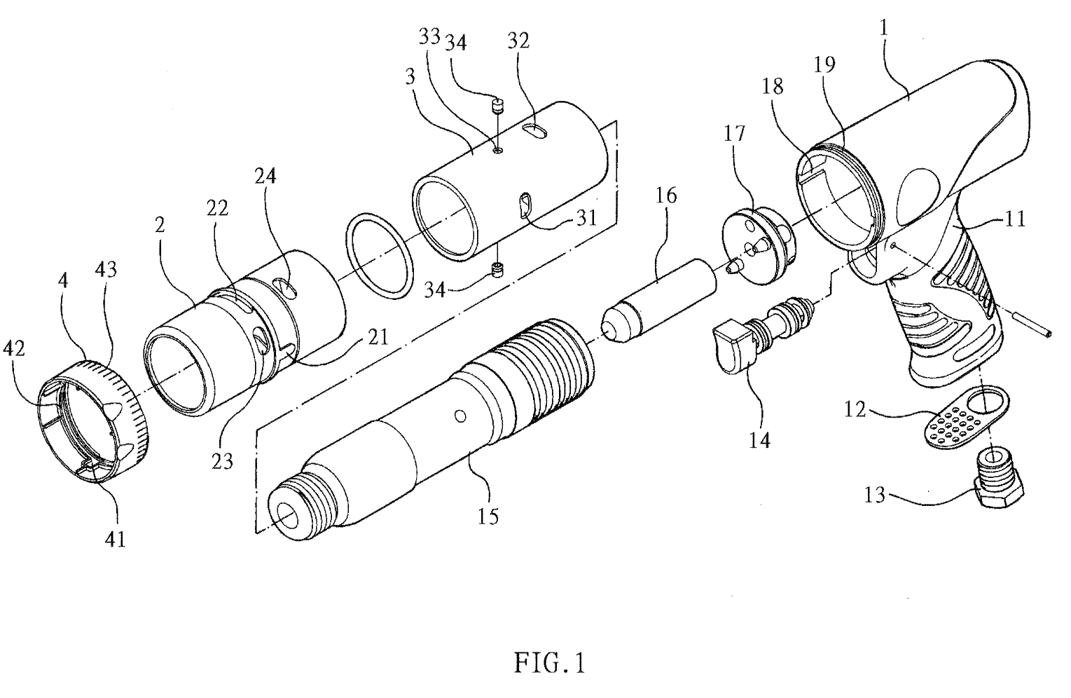

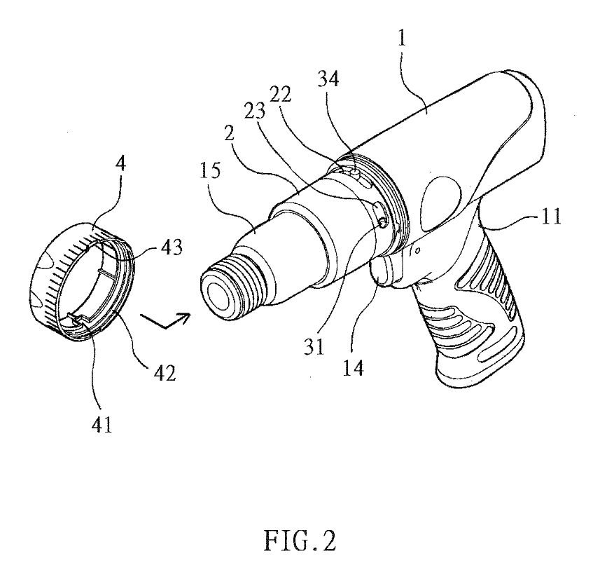

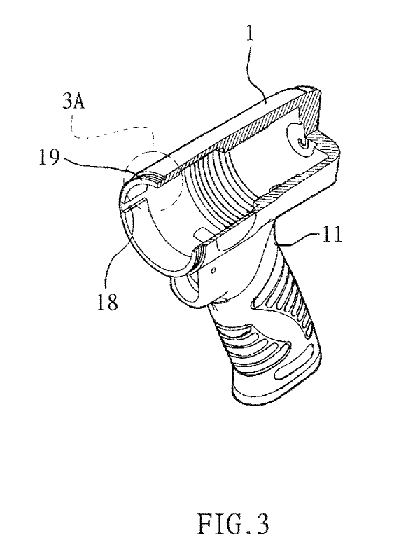

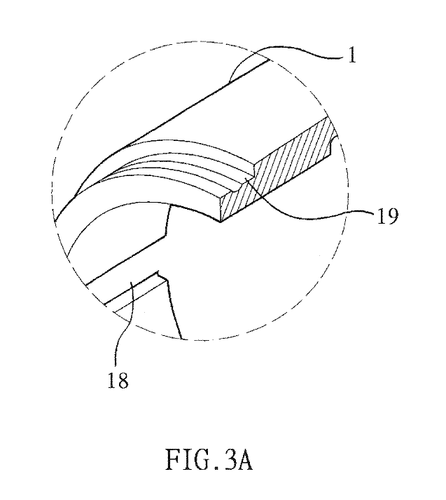

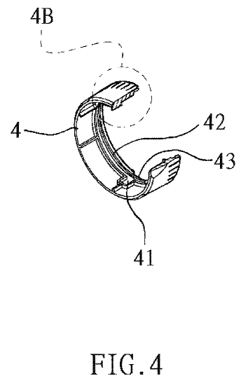

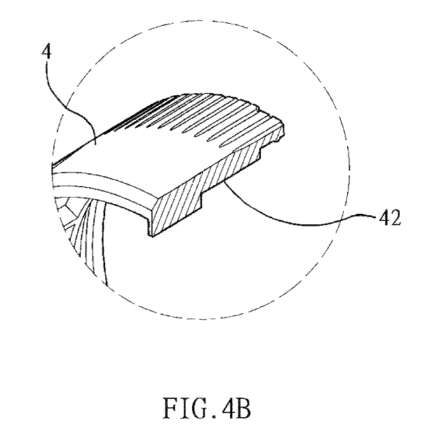

Referring to FIG. 1 and FIG. 2 in conjunction with FIG. 3, FIG. 3A, FIG. 4, and FIG. 4B, which show two exploded perspective views, a perspective view of a tool body, a partial cross-sectional enlarged view of the tool body, a perspective view of an adjustment element, and a partial cross-sectional enlarged view of the adjustment element of the present invention, respectively; and as shown in the diagrams, the present invention primarily comprises a tool body 1. The tool body 1 is fitted with a handle 11, and the bottom edge of the handle 11 is fitted with a cover plate 12, an air inlet 13, and a trigger set 14 is further fitted to the tool body 1. In addition, a cylinder 15, a piston 16, a valve seat set 17, an air guide element 2, a brake element 3, and an adjustment element 4 are installed inside the tool body 1. When using the present invention, the different parts are fitted to the front end of the cylinder 15, and the trigger set 14 is used to control the formation of cutting or drilling operations. Furthermore, an inner edge of the front end of the tool body 1 is provided with two or more than two rabbets 18, and an outer edge of the front end of the tool body 1 is provided with an encircling protruded rib 19.

The air guide element 2 is mounted and disposed on the front end of the tool body 1, the outer edge of the air guide element 2 is provided with positioning ribs 21 corresponding to the rabbets 18 of the tool body 1, and the air guide element 2 is position by inserting and disposing the positioning ribs 21 into the respective rabbets 18. Cut-open grooves 22 are provided at appropriate positions between the positioning ribs 21, and front and rear positions of the cut-open grooves 22 are provided with a first air vent hole 23 and a second air vent hole 24.

The brake element 3 is mounted and disposed on the air guide element 2, and the brake element 3 is provided with a first air guide hole 31 and a second air guide hole 32. Moreover, the brake element 3 is further provided with symmetrically positioned screw holes 33, which are used to respectively lock protruding posts 34 therein and enable the brake element 3 to be mounted and disposed onto the rear of the air guide element 2, after which, the protruding posts 34 can precisely inserted and disposed into the cut-open groove 22 of the air guide element 2 to form a fixed positioning thereof.

The adjustment element 4 assumes a ring shape, the inner edge of which is provided with grooves 41 corresponding to the protruding posts 34 of the brake element 3 and an encircling rabbet 42. The adjustment element 4 is positioned by inserting and disposing the protruded rib 19 into the rabbet 42, which enables the adjustment element 4 to assume a rotatable form. The protruding posts 34 provided on the brake element 3 can then precisely inserted and disposed into the respective grooves 41.

Accordingly, by rotating the adjustment element 4, the protruding posts 34 are pinned down in the respective grooves 41, which further causes rotation of the brake element 3. In addition, the outer edge of the adjustment element 4 is provided with notches 43.

The assembly of the aforementioned structural elements is used to construct the pneumatic tool air discharge device of the present invention, and when using the pneumatic tool, rotation of the adjustment element 4 in a clockwise or counter-clockwise direction is used to cause the air guide element 2 to cover the first air guide hole 31 of the brake element 3 and superpose the second air vent hole 24 over the second air guide hole 32, thereby enabling backward discharge of air, which prevents dust from flying upward to facilitate drilling operations, or the adjustment element 4 is rotated to cause the air guide element 2 to cover the second air guide hole 32 of the brake element 3 and superpose the first air vent hole 23 over the first air guide hole 31, thereby enabling forward discharge of residual shards to facilitate cutting operations.

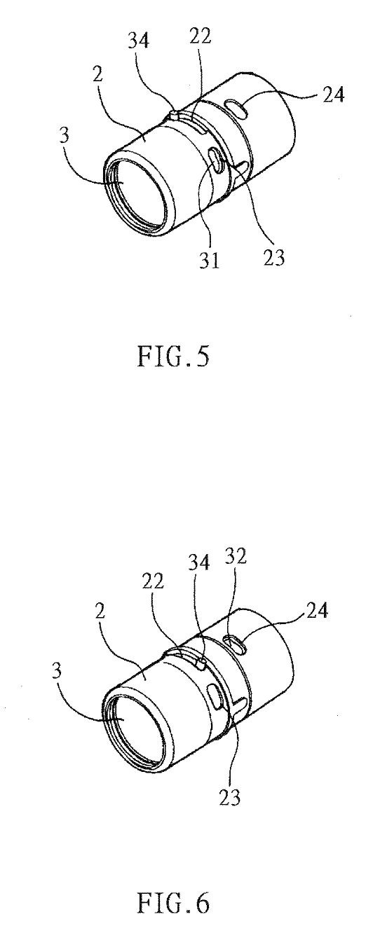

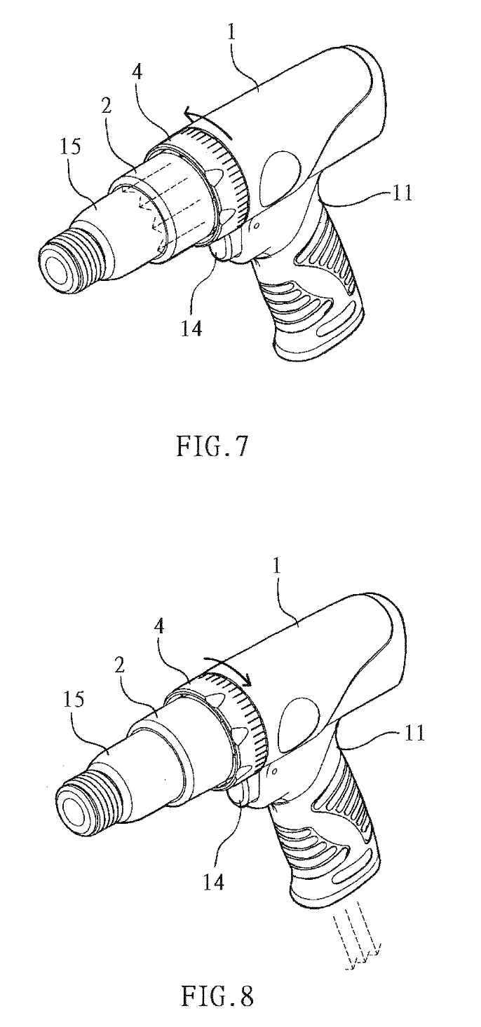

Referring to FIG. 5 and FIG. 7, which show a state diagram of forward air discharge and a state diagram of air vent holes and air guide holes when discharging air forward according to the present invention, respectively; and as shown in the diagrams, when the pneumatic tool of the present invention is being used to carry out cutting operations, the adjustment element 4 is rotated in a counter-clockwise direction to superpose the first air guide hole 31 of the brake element 3 over the first air vent hole 23 of the air guide element 2 (the first air guide hole 31 will not be covered by the air guide element 2), the second air guide hole 32 is then covered by the air guide element 2, thereby enabling forward discharge of residual shards produced during the cutting operations from the front edge of the air guide element 2 and cleared out through the adjustment element 4 to facilitate providing a clearer viewing range of the object being worked on and improve operational efficiency.

Referring to FIG. 6 and FIG. 8, which show a state diagram of backward air discharge and a state diagram of air vent holes and air guide holes when discharging air backward according to the present invention, respectively; and as shown in the diagrams, when the pneumatic tool of the present invention is being used to carry out drilling operations, the adjustment element 4 is rotated in a clockwise direction to superpose the second air guide hole 32 of the brake element 3 over the second air vent hole 24 of the air guide element 2 (the second air guide hole 32 will not be covered by the air guide element 2), the first air guide hole 31 is then covered by the air guide element 2, thereby enabling discharge of air produced during the drilling operations from the rear edge of the air guide element 2 in the direction along the handle 11, thus preventing dust from flying upward to facilitate providing a clearer viewing range of the object being worked on and improve operational efficiency.

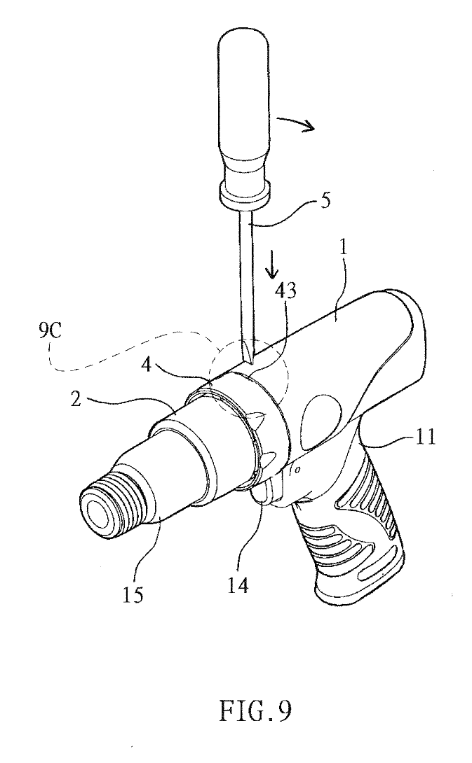

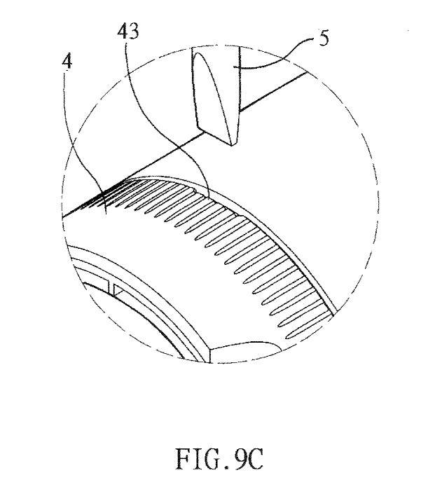

Referring to FIG. 9 and FIG. 9C, which show a state diagram depicting detachment of an adjustment element and a partial enlarged view depicting detachment of the adjustment element of the present invention, respectively; and as shown in the diagrams, when replacing the adjustment element 4 of the present invention, the tip of a tool 5 (screwdriver) is inserted into a notch 43 of the adjustment element 4, the tool 5 is then turned backward to turn up and cause the adjustment element 4 to separate from the brake element 3, thereby facilitating replacement of the adjustment element 4.

In conclusion, the present invention uses an air guide element provided with cut-open grooves and air vent holes, and a brake element provided with air guide holes, together with the functional operation of an adjustment element that is able to drive the brake element to form an air discharge method for a pneumatic tool and a device thereof. When using the pneumatic tool, a simple and easy adjusting rotation is used to cause backward discharge of air to facilitate drilling operations, or cause forward discharge of residual shards to facilitate cutting operations. The present invention provides a practical design for a pneumatic tool, and is indeed a novel invention. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An air discharge method for pneumatic tool and device thereof, wherein a tool body of a pneumatic tool is installed with an air guide element provided with a first air vent hole and a second air vent hole, and a brake element provided with a first air guide hole and a second air guide hole that is mounted and disposed on the air guide element, wherein the brake element is driven by an adjustment element, which causes the brake element to rotate along the air guide element, accordingly, when using the pneumatic tool, the adjustment element is rotated in a clockwise or counter-clockwise direction to cause the air guide element to cover the first air guide hole of the brake element, which superposes the second air vent hole over the second air guide hole, thereby enabling backward discharge of air and preventing dust from flying upward to facilitate drilling operations, or the adjustment element is rotated to cause the air guide element to cover the second air guide hole of the brake element, which superposes the first air vent hole over the first air guide hole, thereby enabling forward discharge of residual shards to facilitate cutting operations.

2. The air discharge method for pneumatic tool and device thereof according to claim 1, wherein an outer edge at a front end of the tool body is provided with an encircling protruded rib, and an inner edge of the adjustment element is provided with a rabbet to enable the adjustment element to insert and dispose therein using the protruded rib, thereby fixing a position of the adjustment element on the tool body.

3. The air discharge method for pneumatic tool and device thereof according to claim 1, wherein an inner edge at a front end of the tool body is provided with rabbets, and an outer edge of the air guide element is provided with positioning ribs corresponding to the rabbets of the tool body to enable inserting and disposing the air guide element into the rabbets using the positioning ribs and fixing a position thereof.

4. The air discharge method for pneumatic tool and device thereof according to claim 1, wherein the air guide element is provided with cut-open grooves, and the brake element is mounted and disposed on the air guide element; the brake element is provided with screw holes that enable locking protruding posts in the screw holes, whereby after mounting and disposing the brake element on the air guide element, the symmetrically positioned protruding posts precisely insert and dispose into the cut-open grooves of the air guide element to fix a position of the brake element.
